(19) United States
(12) Patent Application Publication
(10) Pub. No.: US 2016/0037209 A1
(43) Pub. Date: Feb. 4, 2016

(54) VIDEO AUDIO OUTPUT DEVICE AND SYSTEM

(71) Applicants: Kabushiki Kaisha Toshiba, Tokyo (JP); Toshiba Lifestyle Products & Services Corporation, Tokyo (JP)

(72) Inventor: Eisuke Miyoshi, Shinagawa (JP)

(21) Appl. No.: 14/585,699

(22) Filed: Dec. 30, 2014

Related U.S. Application Data
(60) Provisional application No. 62/031,626, filed on Jul. 31, 2014.

(51) Int. Cl. H04N 21/436; H04N 21/442; H04N 21/4223; H04N 21/443; H04N 21/41; H04N 21/426

(52) U.S. Cl. CPC H04N 21/43615; H04N 21/4122; H04N 21/4263; H04N 21/4223; H04N 21/4436; H04N 21/44218

(57) ABSTRACT

According to one embodiment, video audio output device is connected to an electronic device and reproduces a predetermined content together with the electronic device. The video audio output device includes storage, first module, second module, and seamless reproduction controller. The storage stores correspondence relationship between different position within view of image acquiring device and the electronic device placed outside the view. The image acquiring device acquires an image around the video audio output device. The first module specifies, based on the image, position at which person has disappeared from the view. The second module specifies, based on the correspondence relationship, an electronic device associated with the position specified by the first module. The seamless reproduction controller transmits, to the electronic device specified by the second module, signal for requesting preparation of seamless reproduction of a content that is currently being reproduced by the video audio output device.

### CROSS-REFERENCE TO RELATED APPLICATIONS

This application claims the benefit of U.S. Provisional Patent Application No. 62/031,626, filed Jul. 31, 2014.

### FIELD

Embodiments described herein relate generally to a video audio output device and a system.

### BACKGROUND

Recently, in accordance with price decline of a video audio output device such as a television, there is an increasing opportunity for a household to possess a plurality of video audio output devices. Further, it is becoming popular to connect a plurality of video audio output devices with each other wirelessly or in wired manner, and to transmit and receive data thereamong.

Recently, there is known a technique to simultaneously provide, by using such video audio output devices, the same content for the video audio output devices. Consequently, a user can continuously view a content, which had been viewed by a video audio output device placed in a room from which a user has moved out, by a video audio output device placed in a room into which the user is moving. Further, recently, there is known a technique that recognizes presence of a user by a camera in the video audio output device, and perform power management such as putting a video audio output device not being used for viewing into hibernation.

However, according to such techniques, because the video audio output device in hibernation is initially activated when a person has reached nearby the device, a time lag is caused from when the person has reached the video audio output device and until when the content becomes viewable.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a floor plan of a house in which a plurality of televisions are placed, according to an embodiment;

FIG. 2 is an exemplary block diagram of a hardware configuration of a television in the embodiment;

FIG. 3 is an exemplary block diagram illustrating a functional configuration of a seamless reproduction module in the embodiment;

FIG. 4 is an exemplary diagram of an image acquired by a camera of a television 100A, in the embodiment;

FIG. 5 is an exemplary table illustrating a correspondence relationship between a different position within a camera view and a seamless reproduction target device, in the embodiment;

FIG. 6 is an exemplary sequence diagram of a communication performed between the televisions, in the embodiment;

FIG. 7 is an exemplary flowchart of a seamless reproduction processing by the television currently being viewed by a person, in the embodiment; and

FIG. 8 is an exemplary flowchart of a seamless reproduction processing by a television that has received an activation command, in the embodiment.

### DETAILED DESCRIPTION

In general, according to one embodiment, a video audio output device is connected to an electronic device and configured to reproduce a predetermined content together with the electronic device. The video audio output device comprises a storage, a first specifying module, a second specifying module, and a seamless reproduction controller. The storage is configured to store a correspondence relationship between a different position within a view of an image acquiring device and at least one electronic device placed outside the view. The image acquiring device is configured to acquire an image around the video audio output device. The first specifying module is configured to specify, based on the image acquired by the image acquiring device, a position at which a person has disappeared from the view. The second specifying module is configured to specify, based on the correspondence relationship stored in the storage, at least one electronic device associated with the position specified by the first specifying module. The seamless reproduction controller is configured to transmit, to the at least one electronic device specified by the second specifying module, a signal for requesting preparation of seamless reproduction of a content that is currently being reproduced by the video audio output device.

### Embodiment

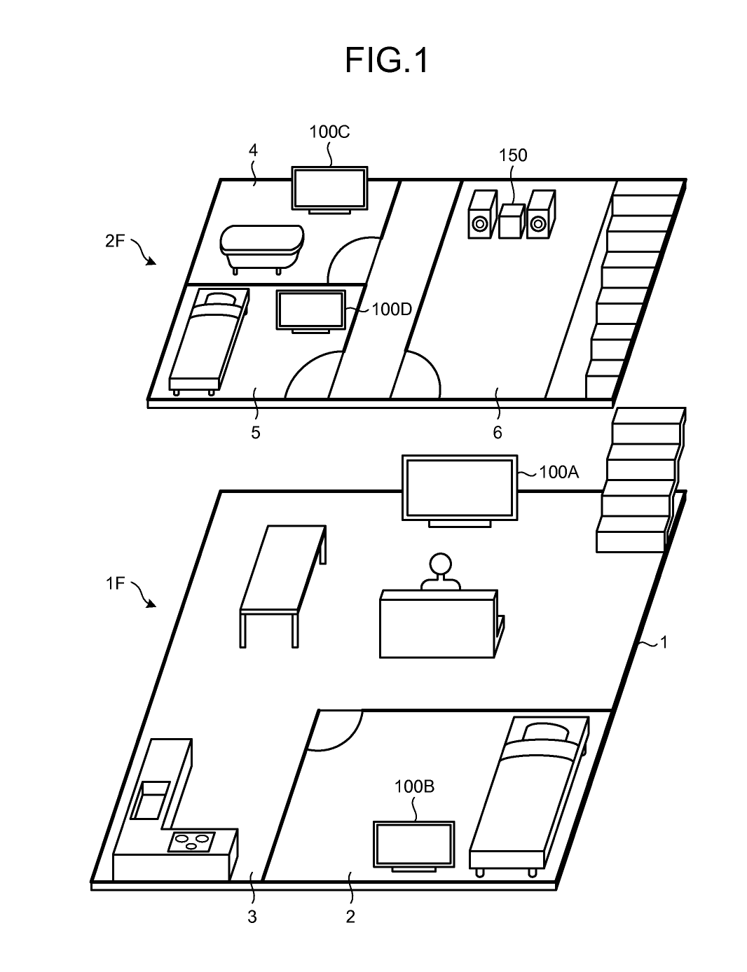

An embodiment is explained with reference to FIGS. 1 to 8. FIG. 1 is a diagram illustrating a floor plan of a house in which a plurality of televisions 100A to 100D of the present embodiment are placed. The house illustrated in FIG. 1 is of two stories. A main living room 1, a guest room 2, and a kitchen 3 are arranged on a first floor of the house. A bathroom 4, a bedroom 5, and a second living room 6 are arranged on a second floor of the house. A television 100A is placed in the main living room 1, a television 100B is placed in the guest room 2, the television 100C is placed in the bathroom 4, the television 100D is placed in the bedroom 5, and an audio device 150 is placed in the second living room 6. Here, the television is one example of a video audio output device.

According to the embodiment, among the devices illustrated in FIG. 1, the televisions 100A to 100D are connected to the Internet via a wireless local area network (LAN), for example. Further, the televisions 100A to 100D constitute a home network by, for example, the wireless LAN, and are capable of communicating with each other or sharing data through the home network. Here, the intercommunication and the data sharing are performed in compliance with any guidelines or standards, such as the digital living network alliance (DLNA).

If a plurality of televisions capable of such an intercommunication and/or data sharing are used, it becomes capable of simultaneously providing the same content (e.g., alive soccer) by televisions placed at different locations in a household. Therefore, a viewer can continually and seamlessly watch the same content anywhere in the house. However, simultaneously and always providing the same content by the televisions means to provide the content even when a television has not been watched by the viewer. Therefore, there is a concern that the power consumption increases.

Therefore, it may be considered to recognize presence of a person around the television by a camera and/or the like, and to manage the power of the television in accordance with the presence of the person. However, according to such a technique, a television in hibernation for example is activated for the first time when a person has reached nearby the television. Thus, a time lag is caused from when the person has reached the television and until when the content becomes capable of being watched. Consequently, it is difficult to say that sufficient continuity is given for a viewer who is watching a content that cannot be missed even for a minute or a second, such as the live soccer.

Thus, according to the present embodiment, a position at which a person has disappeared from around the television is specified, and other television which is associated with the specified position is preliminarily activated. In particular, when a person is moved from the main living room 1 on the first floor to the bedroom 5 on the second floor, the television 100A placed in the main living room 1 detects that the person is moving toward the direction of the second floor from around the television 100A. Then, the televisions 100C and 100D placed on the second floor are preliminarily activated. Consequently, by using the plurality of televisions, a content can seamlessly be provided to a user, and also, only a television with a possibility of being watched by the viewer can be activated.

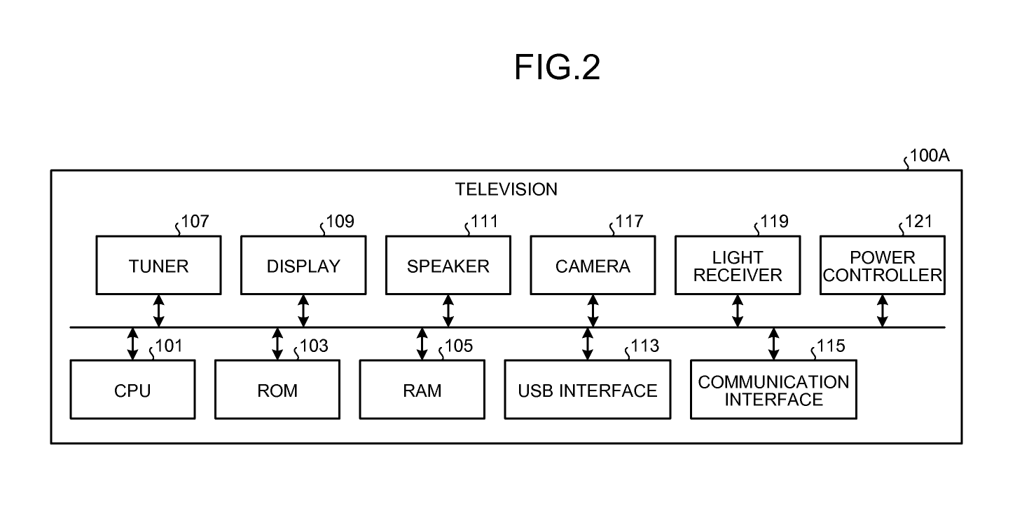

FIG. 2 illustrates a block diagram of a hardware configuration of a television 100A according to an embodiment. The television 100A comprises a central processing unit (CPU) 101, a read only memory (ROM) 103, a random access memory (RAM) 105, a tuner 107, a display 109, a speaker 111, a universal serial bus (USB) 113, a communication interface 115, a camera 117, a light receiver 119, and a power controller 121. Each of the televisions 100B to 100D has a configuration similar to that of the television 100A, thereby explanations thereof are omitted.

The CPU 101 controls operations of each portion of the television 100A. In particular, the CPU 101 sequentially reads out and executes a firmware and various application stored in the ROM 103 to control operations of each portion of the television 100A. The ROM 103 stores therein a firmware, various applications, and various data necessary to execute the firmware and the applications. The RAM 105 provides, as a main memory of the television 100A, a work area for when the CPU 101 executes the firmware and the applications.

The tuner 107 is a predetermined tuner such as, for example, a terrestrial digital tuner or a broadcasting satellite (BS) digital tuner. The tuner 107 selects a desired channel in response to operation information of a user received from a remote controller not illustrated via, for example, a later described light receiver 119. The tuner 107 acquires broadcast signals of content broadcasted via the selected channel. The CPU 101 performs predetermined signal processing on the broadcast signals acquired by the tuner 107. Then, the CPU 101 outputs video signals to the later described display 109, and outputs audio signals to the later described speaker 111. The CPU 101 may output the broadcast signals to which the predetermined signal processing is performed to the later described USB interface 113 or to the later described communication interface 115. Here, the predetermined signal processing is processing required to output the received broadcast signals to the display 109 and the speaker 111. The predetermined signal processing comprises, for example, descrambling, decoding, phase shift keying (PSK) demodulation, high resolution image process, and high quality process, for the case when the tuner 107 is the terrestrial digital tuner.

The display 109 is a flat panel display such as, for example, a liquid crystal display (LCD). The display 109 receives an input of the video signals processed by the CPU 101, and display a screen corresponding to the video signals. The speaker 111 receives an input of the audio signals processed by the CPU 101, and outputs audio corresponding to the audio signals.

The USB interface 113 is connected to, for example, a USB connected external hard disk drive (HDD) via a USB cable not illustrated. The USB connected external HDD is used as a recording destination of the content received from the tuner 107, the content acquired from the later described communication interface 115, and/or the like. The content stored in the USB connected external HDD is read out by the CPU 101 based on the operation information of the user received via the later described light receiver 119, for example, and output to the display 109 and the speaker 111 after the predetermined signal processing is performed thereon, if necessary.

The communication interface 115 is connected to the Internet via a wireless local area network (LAN) for example, and acquires the content distributed via the Internet. Further, the communication interface 115 is connected to a home network via the wireless LAN, for example, and performs intercommunication and/or data sharing with respect to other devices on the home network.

The camera 117 is, for example, a charge coupled device (CCD) camera or a complementary metal oxide semiconductor (CMOS) camera. The camera 117 is provided anywhere on the television 100A, and time sequentially acquires an image around the television 100A.

The light receiver 119 receives, as the operation information, operation of a user performed with respect to the remote controller not illustrated through infrared light. The CPU 101 controls operations of each portion of the television 100A based on the operation information received by the light receiver 119.

The power controller 121 supplies power supplied from a power source not illustrated to each portion of the television 100A. Further, the power controller 121 controls supplying power to each portion of the television 100A so as to put the television 100A in hibernation or to wake up the television 100A from hibernation. In the following, “hibernation” corresponds to a state in which at least a portion of power supply to each portion of the television 100A is stopped, such as for example a standby mode. Further, in the following, “wake up from hibernation” means to activate the television from hibernation, and corresponds to a state in which content is ready to be reproduced via a display and/or a speaker of its own device.

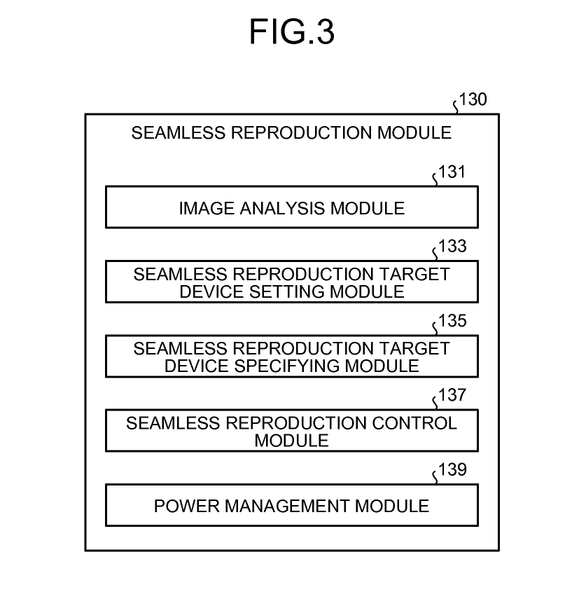

Next, a seamless reproduction module 130 stored in the ROM 103 as a program is explained. The CPU 101 sequentially executes each portion (image analysis module 131, a seamless reproduction target device setting module 133, a seamless reproduction target device specifying module 135, a seamless reproduction control module 137, a power management module 139) of the seamless reproduction module 130 stored in the ROM 103 to realize functions of the seamless reproduction module 130. FIG. 3 is a block diagram illustrating functional configurations of the seamless reproduction module 130 of the present embodiment. As illustrated in FIG. 3, the seamless reproduction module 130 comprises the image analysis module 131, the seamless reproduction target device setting module 133, the seamless reproduction target device specifying module 135, the seamless reproduction control module 137, and the power management module 139.

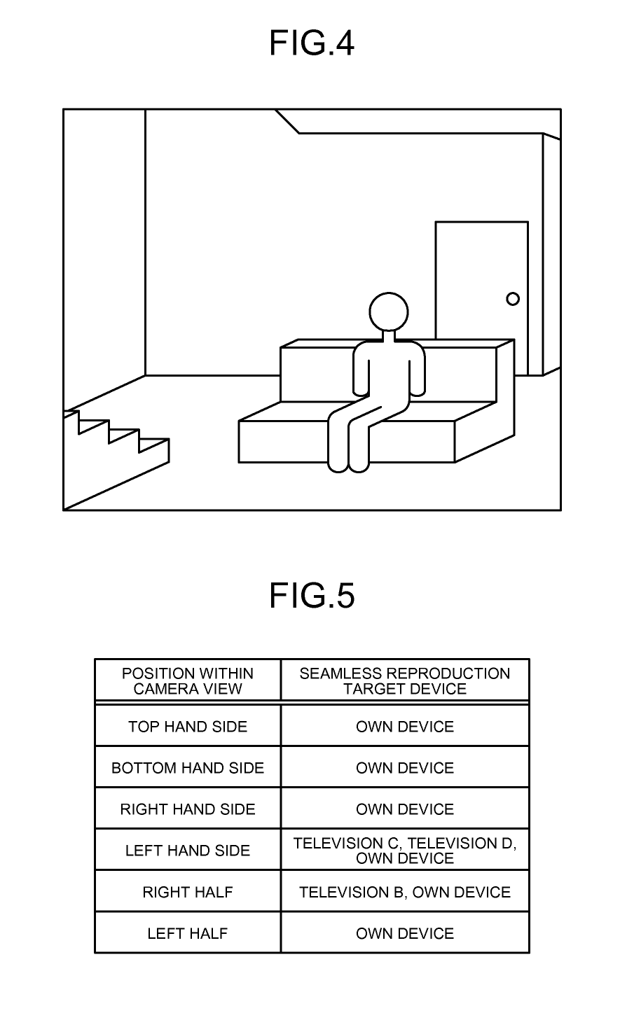

The image analysis module 131 acquires the images acquired by the camera 117 of the television 100A in time series. FIG. 4 is an exemplary diagram of an image of the main living room 1 acquired by the camera 117 of the television 100A. As illustrated in FIG. 4, there exists a person sitting on a couch in the middle of the image acquired by the camera 117. Further, stairs that leads to the second floor is arranged on the left hand side of the image, and a door that leads to the guest room 2 is arranged on the right half of the image. The right hand side of the image leads to the kitchen 3. On the other hand, the upper hand side, the lower hand side, and the left half of the image are walls of the main living room 1, therefore are dead ends.

Further, the image analysis module 131 analyzes the acquired image, and specifies a position within a view of the camera 117 where a person has disappeared (hereinafter, referred to as a person disappeared position). In particular, in case when for example a person moves out from the main living room 1 to the second floor, the person disappears into the left end of the view of the camera 117 because the person uses the stairs. Therefore, the image analysis module 131 analyzes the acquired image, and specifies the person disappeared position as “left hand side” of the camera view. Further, in case when for example a person moves from the main living room 1 to the kitchen 3, the person disappears into the right end of the view of the camera 117. Thus, the image analysis module 131 analyzes the acquired image, and specifies the person disappeared position as “right hand side” of the camera view. Still further, in case when a person moves from the living room 1 to the guest room 2, the person disappears into the right half of the view of the camera 117 since the person uses the door that leads to the guest room 2 from the main living room 1. Thus, the image analysis module 131 analyzes the acquired image, and specifies the person disappeared position as “right half” of the camera view.

Further, the image analysis module 131 analyzes the acquired image, and specifies whether a person enters into the view of the camera 117.

The image analyzing algorithm by the image analysis module 131 of the present embodiment is not limited to any particular one. That is to say, any algorithm can be used as long as the algorithm can specify the fact that a person disappears from the camera view, a position within the camera view where the person disappears, and the fact that the person enters into the camera view.

Referring back to FIG. 3, the seamless reproduction target device setting module 131 performs setting to associates each of different positions within the view of the camera 117 of the television 100A to a device that is to be a target for seamless reproduction (hereinafter, referred to as a seamless reproduction device). Then, the seamless reproduction target device setting module 133 stores the set correspondence relationship in, for example, the ROM 103. The different positions within the camera view means, for example, the “top hand side”, “bottom hand side”, “right hand side”, “left hand side”, “right half”, and “left half” of the image illustrated in FIG. 4. Further, the seamless reproduction means to continually reproduce content, which has currently been viewed by a viewer through the television 100A, by other television placed at a location to which the viewer is moving so that the viewer can continually view the same content by the other television.

FIG. 5 is a table illustrating the correspondence relationship between a different position within the view of the camera 117 of the television 100A and a seamless reproduction target device. As illustrated in FIG. 5, the seamless reproduction target device setting module 133 sets a seamless reproduction target device of when a person disappears at “left hand side” of the view of the camera 117 as “television 100C”, “television 100D”, and “own device”. Further, the seamless reproduction target device setting module 133 sets a seamless reproduction target device of when a person disappears at the right half of the view of the camera 117 as “television 100B” and “own device”. On the other hand, the seamless reproduction target device setting module 133 sets a seamless reproduction target device of when a person disappears at “top hand side”, “bottom hand side”, “right hand side”, and “left half” of the view of the camera 117 as “own device”.

The setting of the seamless reproduction target device may for example be performed at the timing of initial setting of the television 100A. In particular, the seamless reproduction target device setting module 133 is for example configured so as to prompt the user to set the seamless reproduction target device via the initial setup screen of the television 100A, at the timing of initial setting immediately after the television 100A is purchased. At this time, the seamless reproduction target device setting module 133 sequentially displays a predetermined position (e.g., “top hand side” or “bottom hand side”) within the view on the display 109, and prompts the user to input a seamless reproduction device which corresponds to that position. Consequently, it becomes possible for a user to associates a different position within the camera view with a seamless reproduction target device.

Referring back to FIG. 3, the seamless reproduction target device specifying module 135 refers to the ROM 103, and specifies a seamless reproduction target device corresponding to the person disappeared position specified by the image analysis module 131. In particular, in case when for example a person disappears into the left hand side within the camera view, the seamless reproduction target device specifying module 135 specifies the television 100C and the television 100D located on the second floor as the seamless reproduction target device. Then, the seamless reproduction target device specifying module 135 sends an activation command to the televisions 100C and 100D. Here, the “activation command” is an instruction to activate the seamless reproduction target device. In case when for example the seamless reproduction target device is in hibernation, the activation command wakes up the device from the hibernation.

Upon receipt of a request for seamless reproduction from a television from which the activation command is received, the seamless reproduction control module 137 performs control to acquire and reproduce content that is currently being reproduced by the television from which the activation command is received. Here, the present embodiment is not limited thereto, and for example, the seamless reproduction control module 137 may acquire only the display output of the television from which the activation command is received by using the Miracast, and reproduce the content. Further, the seamless reproduction control module 137 may acquire the content that is currently being reproduced by the television from which the activation command is received from a server such as a digital media server (DMS), and reproduce the content. Still further, the seamless reproduction control module 137 may acquire and reproduce the content from a predetermined server through the Internet. Still further, the seamless reproduction control module 137 may acquire channel information or program information of content that is currently being reproduced by the television from which the activation command is received from the television, and acquire the content via broadcasting wave by setting the tuner based on the acquired information.

Although the details will be described later, the power management module 139 controls the power controller 121 so that the television 100A is put into hibernation in response to the recognition information and/or a lapse of predetermined time. The “recognition information” is information transmitted by other device when a camera 117 provided in the other device captures a person. In other word, the “recognition information” is information notified when a person has reached the other device.

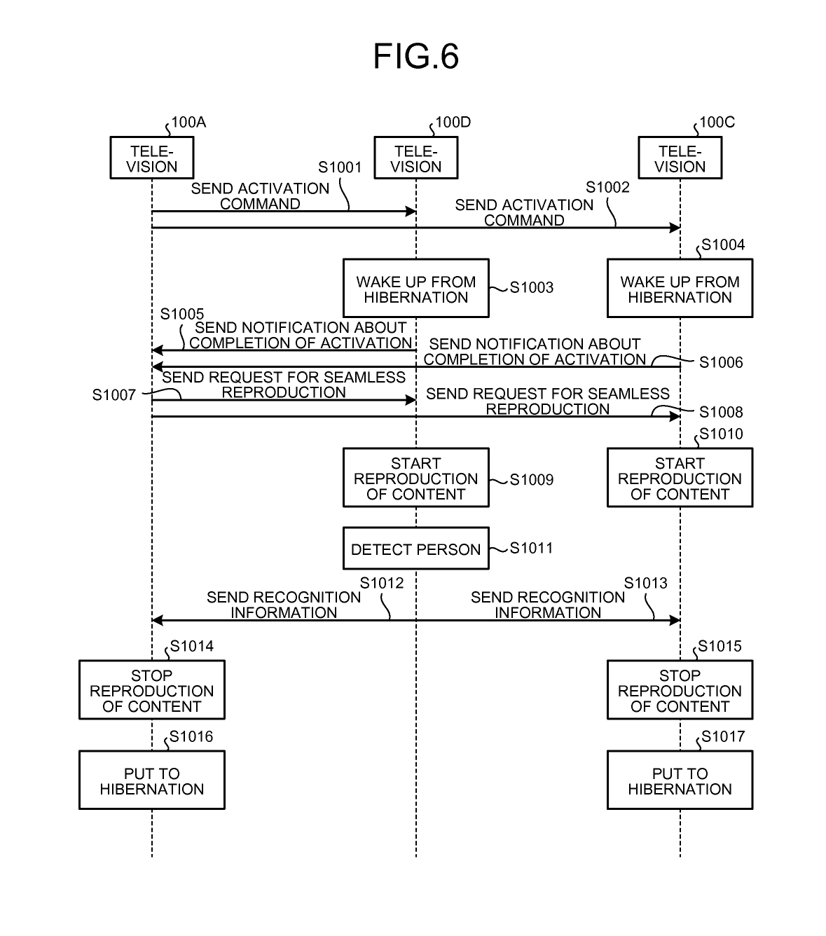

Next, communication between televisions on the home network and performed in accordance with movement of a person is explained. Here, processing performed in each of the televisions is described later, and the communication between the television is focused and an outline thereof is explained. FIG. 6 is a sequence diagram for explaining communication among the televisions 100A, 100C, and 100D, and performed in accordance with the movement of a person. FIG. 6 illustrates an example of a case when a person who is currently viewing content by the television 100A placed in the main living room 1 on the first floor moves to the bedroom 5 on the second floor. Further, at the beginning of the sequence of FIG. 6, the television 100A is active and reproducing the content, and the televisions 100C and 100D are in hibernation.

As illustrated in FIG. 6, when a person who has been viewing the content is moved to the second floor from the main living room 1, the television 100A sends an activation command to all of the televisions (the televisions 100C and 100D) located on the second floor (S1001, S1002). As a result, the televisions 100C and 100D wake up from the hibernation (S1003, S1004). Subsequently, each of the televisions 100C and 100D sends a notification notifying that activation of the each of the televisions 100C and 100D is completed, to the television 100A (S1005, S1006).

Next, the television 100A requests the televisions 100C and 100D from which the notification about the completion of the activation is received to perform the seamless reproduction (S1007, S1008). Then, each of the televisions 100D and 100C begins acquisition and reproduction of the content (S1109, S1110).

Next, when a person who moved to the second floor has reached the bedroom 5, the television 100D detects presence of the person around the television 100D (S1011), and sends the recognition information to the televisions 100A and 100C (S1012, S1013). In response, each of the televisions 100A and 100C stops reproduction of the content (S1014, S1015), and is put into hibernation (S1016, S1017).

As described above, according to the present embodiment, at the timing when a person disappears from in front of the television 100A, the activation command is sent to the televisions 100C and 100D that are predicted as a destination to which the person is moving. Accordingly, the televisions 100C and 100D take over the reproduction of the content before the person reaches the televisions 100C and 100D. Further, when the television 100D confirms that the person has reached thereto, the television 100D sends the recognition information to the televisions 100A and 100C to put the televisions 100A and 100C in hibernation. Consequently, it becomes capable of putting the televisions that are not currently being viewed to hibernation to suppress power consumption. Further, it becomes capable of seamlessly providing the content to the viewer by preliminarily waking up the television to which the person is moving from hibernation.

Next, processing specific to each of the televisions illustrated in FIG. 6 is described in details.

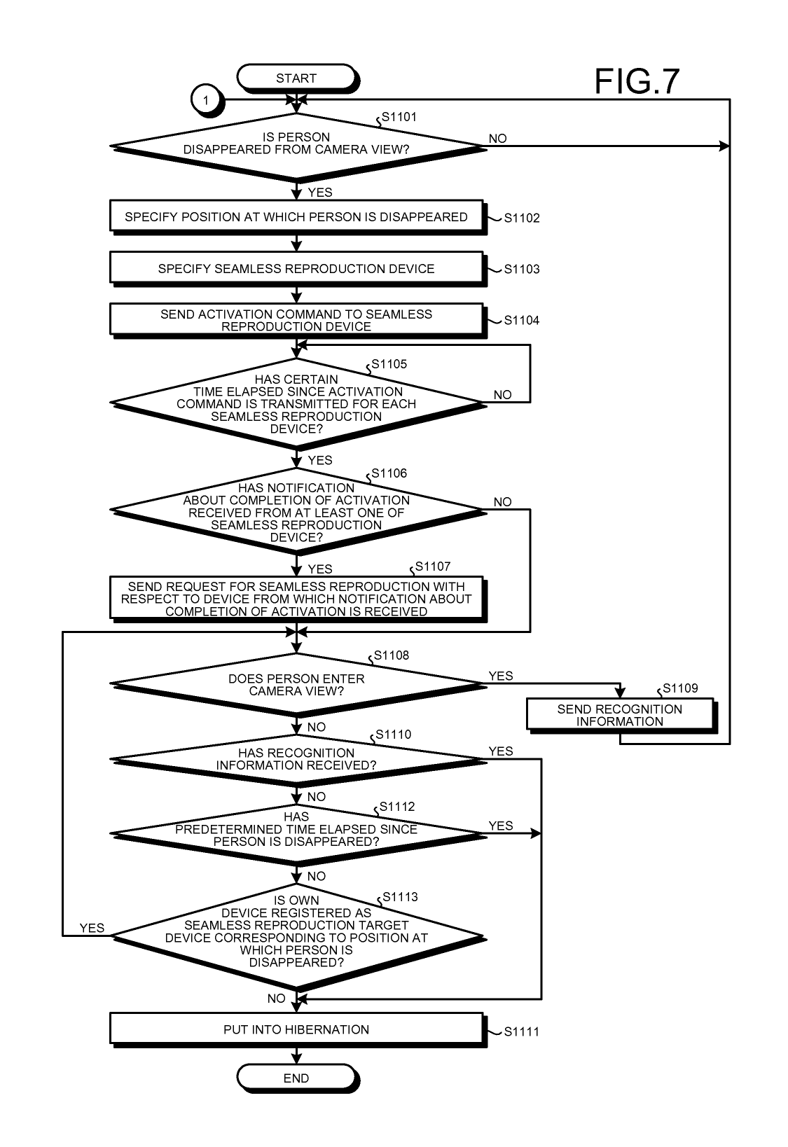

First, processing by the seamless reproduction module 130 of the television 100A through which the person is currently viewing the content is explained. FIG. 7 is a flowchart illustrating processing of the seamless reproduction module 130 of the television 100A illustrated in FIG. 6 and by which the person is currently viewing the content.

As illustrated in FIG. 7, the image analysis module 131 determines whether the person disappears from the view of the camera 117 based on an image acquired by the camera 117 (S1101). Then, when it is determined that the person has not disappeared from the view of the camera 117 (No at S1101), the image analysis module 131 repeats the process from S1101. On the other hand, when it is determined that the person has disappeared from the camera view (Yes at S1101), the image analysis module 131 specifies the person disappeared position (S1102).

Next, the seamless reproduction target device specifying module 135 refers to the table stored in the ROM 103, and specifies a seamless reproduction target device corresponding to the person disappeared position specified by the image analysis module 131 (S1103). Then, the seamless reproduction control module 137 sends the activation command to the specified seamless reproduction target device (S1104).

Next, the seamless reproduction control module 137 determines whether a predetermined time has elapsed since when the activation command is transmitted, for each of the seamless reproduction devices (S1105). As a result, when it is determined that the predetermined time has not elapsed since when the activation command is transmitted (No at S1105), the seamless reproduction control module 137 repeats the process of S1105 until the predetermined time elapses, for at least one seamless reproduction device for which it is determined that the predetermined time has not elapsed since the activation command is transmitted.

On the other hand, when it is determined that the predetermined time has elapsed since the activation command is transmitted (Yes at S1105), the seamless reproduction control module 137 determines whether the notification about the completion of the activation is received from at least one seamless reproduction device for which it is determined that the predetermined time has elapsed since the activation command is transmitted (S1106). As a result, when it is determined that the notification about the completion of the activation is received (Yes at S1106), a request for the seamless reproduction is transmitted to the device which has sent the notification about the completion of activation (S1107). Then, the image analysis module 131 determines whether a person enters the view of the camera 117 based on the image acquired by the camera 117 (S1108). On the other hand, when it is determined by the seamless reproduction control module 137 that the notification of the activation completion has not been received (No at S1106), processing of S1108 is performed without going through S1107.

As a result, when it is determined that the person has entered the view of the camera 117 (Yes at S1108), the power management module 139 transmits the recognition information to other device on the home network (S1109) and repeats the process from S1101. Here, the recognition information is transmitted at S1109 in order to take into account the case when a person moves away from in front of the television 100A and returns back to in front of the television 100A without reaching any other devices. That is to say, the recognition information is transmitted at S1109 in order to notify the other television that the person moves away from in front of the television 100A and returns back to in front of the television 100A without reaching any other devices, and puts the other television in hibernation.

Next, when it is determined that the person does not enter the view of the camera 117 (No at S1108), the power management module 139 determines whether the recognition information is received from other device (S1110). As a result, when it is determined that the recognition information is received (Yes at S1110), the power management module 139 puts the television 100A in hibernation (S1111).

On the other hand, when it is determined that the recognition information has not received (No at S1110), the power management module 139 determines whether a predetermined time (e.g., 15 minutes) has elapsed since the person has disappeared from in front of the television 100A (S1112). As a result, when it is determined that the predetermined time has elapsed (Yes at S1112), the power management module 139 puts the television 100A in hibernation (S1111). Here, it is determined whether the predetermined time has elapsed since the person disappears at S1112 in order to put its own device in hibernation for the case in which a person goes outside without being detected by other device for example.

On the other hand, when it is determined that the predetermined time has not been elapsed since the person has disappeared (No at S1112), the power management module 139 determines whether the television 100A is registered as the seamless reproduction target device corresponding to the person disappeared position (S1113). Then, when it is determined that the television 100 is registered as a seamless reproduction target device that corresponds to the person disappeared position (Yes at S1113), the image analysis module 131 repeats processing from S1107.

On the other hand, when it is determined that the television 100A is not registered as the seamless reproduction target device that corresponds to the person disappeared position (No at S1113), the power management module 139 puts the television 100A in the hibernation (S1111).

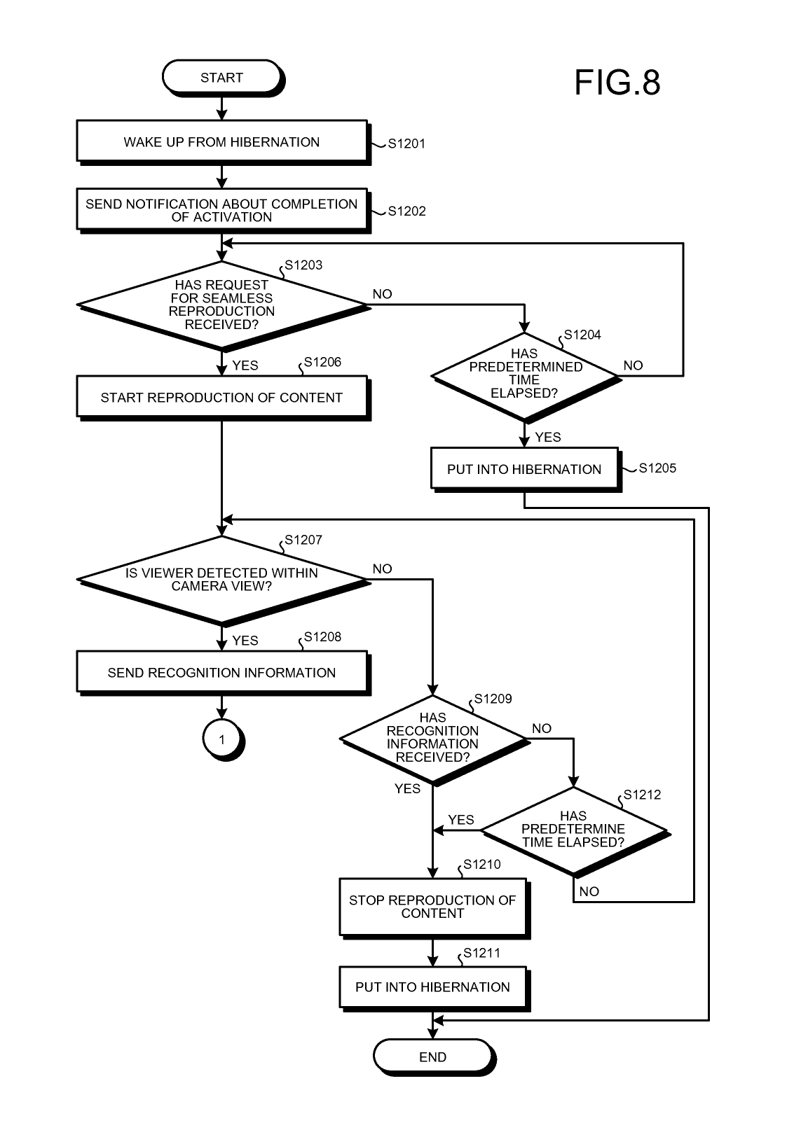

Next, processing of a television to which the activation command is sent is explained. FIG. 8 is a flowchart illustrating processing of a television 100B illustrated in FIG. 6 and to which the activation command is sent.

First, when the activation command is sent by the television 100A, the power controller 121 of the television 100B controls power supply to each portion of the television 100B to wake up the television 100B from hibernation (S1201). Then, the seamless reproduction control module 137 of the television 100B sends the notification about the activation completion to the television 100A (S1202).

Next, the seamless reproduction control module 137 of the television 100B determines whether a request for seamless reproduction is received from the television 100A (S1203). As a result, when it is determined that the request for seamless reproduction is not received (No at S1203), the power management module 139 of the television 100B determines whether a predetermined time (e.g., 1 minute) has elapsed since the time the notification about the completion of activation is transmitted (S1204).

Then, when the predetermined time has not been elapsed (No at S1204), processing from S1203 is repeated. On the other hand, when the predetermined time has been elapsed (Yes at S1204), the power management module 139 puts the television 100B in hibernation (S1205).

On the other hand, when it is determined at S1203 that the request for seamless reproduction is received (Yes at S1203), the seamless reproduction control module 137 acquires and reproduces the content (S1206). Next, the image analysis module 131 of the television 100B determines whether a person is detected within the view of the camera 117 provided to the television 100B (S1207). As a result, when the person is detected (Yes at S1207), the power management module 139 transmits the recognition information to other televisions on the home network (S1208). Subsequently, the processing of FIG. 7 is performed while the content is being reproduced.

On the other hand, when it is determined that the person is not detected within the view of the camera 117 provided in the television 100B (No at S1207), the power management module 139 of the television 100B determines whether the recognition information is received from other television on the home network (S1209). As a result, when it is determined that the recognition information is received (Yes at S1209), the seamless reproduction control module 137 stops reproduction of the content (S1210). Subsequently, the power management module 139 puts the television 100B in hibernation (S1211).

On the other hand, when it is determined that the recognition information is not received (No at S1209), the power management module 141 determines whether a predetermined time (e.g., 30 minutes) has elapsed since the television 100B wakes up from hibernation (S1212). As a result, when it is determined that the predetermined time has elapsed (Yes at S1212), the processing from S1210 is performed.

On the other hand, when it is determined that the predetermined time has not elapsed (No at S1212), the processing from S1207 is repeated.

As described above, according to the present embodiment, presence and absence of a person who is currently watching a television is recognized by a camera provided to the television. Then, based on a position within the camera view from which the person disappears, a television placed at a location toward which the person is moving is preliminarily activated. Subsequently, the content that is currently being reproduced by the television from which the person left is continually reproduced by the television to which the person is moving. Consequently, a television toward which a viewer is moving can preliminarily be activated, thereby the content can seamlessly be provided for the viewer. Further, since only a television with possibility of being watched by a viewer is activated and the content is reproduced thereby, it becomes possible to suppress the power consumption.

In the present embodiment, an example in which a television is provided in a house of a layout illustrated in FIG. 1. However, the present embodiment is not limited thereto, and the television can be provided in a house of different layout such as, for example, one room or a three story building.

Further, in the present embodiment, there is explained an example in which the video audio output device is applied to a television. However, the present embodiment is not limited thereto. The video audio output device can be applied to any device (e.g., a device configured to reproduce only video, a device configured to reproduce only audio, or a device configured to reproduce both video and audio) as long as the device can detect a position at which a person disappears and can reproduce content, such as for example a desktop PC with a camera.

Further, in the present embodiment, the person disappeared position is set for the “top hand side”, “bottom hand side”, “right hand side”, “left hand side”, “right half”, and “left half”. However, the present embodiment is not limited thereto, and any position within the camera view can be set as the person disappeared position.

Further, in the present embodiment, an example in which a camera is provided to each of the televisions 100A to 100D and movement of the person is recognized is explained. However, the present embodiment is not limited thereto, and for example, the television and the camera can be provided separately. In such a case, the camera can be positioned anywhere as long as the camera can capture an image of within a range in which the person can view the television.

Further, in the present embodiment, an example in which at least a portion of power supply to each portion of a television is stopped for hibernation is explained. However, the present embodiment is not limited thereto, and for example, all of the power supply to each portion of the television may be stopped.

Further, in the present embodiment, an example in which the television is put to hibernation is explained. However, the present embodiment is not limited thereto, and the television may be put into any state as long as energy saving can be realized, such as a state in which power of the television is turned off.

### First Modification

In the first embodiment, an example in which the seamless reproduction is performed without identifying a person is explained. However, the present embodiment is not limited thereto, and different person may be identified and the seamless reproduction may be performed for content that is currently being viewed by each different person.

In particular, a function which can identify different persons, such as for example face recognition function, is provided to a television. Then, among a plurality of persons who are watching different contents on the same television by two screens display, for example, one of the persons who disappeared from the camera view is identified, and information about the one of the persons is transmitted to the seamless reproduction target device. Consequently, even when a plurality of persons are present, the seamless reproduction may appropriately be performed for the content currently being viewed by each person.

### Second Modification

In the first embodiment, an example in which the seamless reproduction process is performed without identifying a person is explained. However, the present embodiment is not limited thereto, and different persons may be identified and the seamless reproduction can be performed only to the content that is currently being viewed by person with high priority.

In particular, a priority order of people who perform the seamless reproduction is preliminarily set, for example, and the priority order is shared among a plurality of televisions. Further, a function capable of identifying a person, such as for example face recognition, is provided to each television. Then, when a plurality of persons are viewing the same television, the different persons are identified and the seamless reproduction is performed for the content that is currently being viewed by a person who has the highest priority order. Consequently, even when a person with lower priority order disappears from the television view, a person with higher priority order can continuously view the content.

### Third Modification

In the first embodiment, an example in which only the televisions 100A to 100D are connected to each other via a home network is explained. However, the present embodiment is not limited thereto, and for example, an audio device 150 and/or the like may be connected to the home network and the audio device 150 can be set as the seamless reproduction target device.

In particular, for example, the television 100C, the television 100D, and the audio device 150 are set as seamless reproduction target devices corresponding to the “left hand side”, which is the position within the camera view, in the table of FIG. 5. Consequently, the seamless reproduction of content can be performed by using a home appliance such as for example an audio device and/or the like.

Here, the audio device generally can only reproduce audio signal. Therefore, when the audio device is set as the seamless reproduction target device, it may be configured to only output an audio signal of the content currently being viewed to the audio device.

Further, in the present modification, an example in which the audio device is set as the seamless reproduction target device is explained. However, the present modification is not limited thereto, and any home appliance such as for example a microwave and/or a refrigerator can be set as the seamless reproduction target device. In such a case, for example, a display and/or the like of a microwave is used to seamlessly reproduce caption information included in the content. Consequently, content can be seamlessly reproduced in view of functions of a home appliance set as the seamless reproduction target device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video audio output device connected to an electronic device and configured to reproduce a predetermined content together with the electronic device, the video audio output device comprising:
a storage configured to store a correspondence relationship between a different position within a view of an image acquiring device and at least one electronic device placed outside the view, the image acquiring device being configured to acquire an image around the video audio output device;
a first specifying module configured to specify, based on the image acquired by the image acquiring device, a position at which a person has disappeared from the view;
a second specifying module configured to specify, based on the correspondence relationship stored in the storage, at least one electronic device associated with the position specified by the first specifying module; and
a seamless reproduction controller configured to transmit, to the at least one electronic device specified by the second specifying module, a signal for requesting preparation of seamless reproduction of a content that is currently being reproduced by the video audio output device.

2. The video audio output device of claim 1, further comprising a power management module configured to receive a signal indicating that the person has reached the at least one electronic device, and in response to the received signal, to put the video audio output device in a power saving mode or to turn off a power of the video audio output device.

3. The video audio output device of claim 1, wherein the seamless reproduction controller is configured to transmit, in real time, a content that is currently being reproduced by the video audio output device to the at least one electronic device specified by the second specifying module.

4. The video audio output device of claim 1, wherein the seamless reproduction controller is configured to transmit, in real time, information related to a content that is currently being reproduced by the video audio output device to the at least one electronic device specified by the second specifying module.

5. The video audio output device of claim 4, wherein the information related to the content is information indicating a channel of the content that is currently being reproduced.

6. The video audio output device of claim 1, wherein
the first specifying module specifies one of a plurality of persons who has disappeared from the view, together with a position at which the one of the persons has disappeared from the view, and
the seamless reproduction controller transmits, to the at least one electronic device specified by the second specifying module, information related to the one of the persons who has disappeared from the view, together with the signal.

7. The video audio output device of claim 1, wherein
the first specifying module is configured to specify, based on an image acquired by the image acquiring device, a plurality of persons within the view of the image acquiring device, and,
only when one of the specified persons with a highest priority order has disappeared from the view, the first specifying module is configured to specify the position at which the one of the persons has disappeared.

8. A video audio output device connected to an electronic device and configured to reproduce a predetermined content together with the electronic device, the video audio output device comprising:
a power controller configured to receive, from the electronic device, a signal transmitted from the electronic device when a person moves away from the electronic device, and in response to the received signal, to set the video audio output device to be in a state in which the video audio output device is capable of performing seamless reproduction of a content that is currently being reproduced by the electronic device.

9. The video audio output device of claim 8, further comprising a specifying module configured to specify, based on an image acquired by an image acquiring device, whether a person has reached the video audio output device, the image acquiring device being configured to acquire an image around the video audio output device, wherein,
when it is specified by the specifying module that the person has not reached the video audio output device, the power controller puts the video audio output device in a power saving mode or turns off a power of the video audio output device.

10. The video audio output device of claim 8, wherein, when it is determined by the specifying module that the person has reached the video audio output device, the power controller transmits a signal indicating that the person has reached the video audio output device to the electronic device.

11. The video audio output device of claim 8, further comprising a seamless reproduction controller configured to receive, from the electronic device and in real time, a content that is currently being reproduced by the electronic device, and to perform seamless reproduction of the received content.

12. The video audio output device of claim 8, further comprising a seamless reproduction controller configured to receive, from the electronic device and in real time, information related to a content that is currently being reproduced by the electronic device, and to perform seamless reproduction of the content based on the received information.

13. The video audio output device of claim 12, further comprising a tuner configured to select a channel of a predetermined broadcasting wave, wherein
the information related to the content is information indicating a channel of the content that is currently being reproduced by the electronic device,
the tuner is configured to select, based on the information, a channel through which a content currently being reproduced by the electronic device is provided, and
the seamless reproduction controller is configured to reproduce the content received through the tuner.

14. The video audio output device of claim 8, wherein the seamless reproduction controller is configured to receive, together with the signal, a signal indicating one of a plurality of persons who has moved away from the electronic device, and to set the video audio output device in a state in which the person who has moved away from the electronic device can perform seamless reproduction of the content currently being reproduced by the electronic device.

15. A system comprising:
an electronic device; and
a video audio output device connected to the electronic device and configured to reproduce a predetermined content together with the electronic device, wherein
the video audio output device comprises:
a storage configured to store a correspondence relationship between a different position within a view of an image acquiring device and at least one electronic device placed outside the view, the image acquiring device being configured to acquire an image around the video audio output device;
a first specifying module configured to specify, based on the image acquired by the image acquiring device, a position at which a person has disappeared from the view;
a second specifying module configured to specify, based on the correspondence relationship stored in the storage, at least one electronic device associated with the position specified by the first specifying module; and
a seamless reproduction controller configured to transmit, to the at least one electronic device specified by the second specifying module, a signal for requesting preparation of seamless reproduction of a content that is currently being reproduced by the video audio output device, and
the electronic device comprises a power controller configured to receive a signal transmitted by the seamless reproduction controller, and in response to the received signal, to set the electronic device in a state in which the electronic device can seamlessly reproduce a content currently being reproduced by the video audio output device.
